(19) United States
(12) Patent Application Publication
(10) Pub. No.: US 2024/0020257 A1
(43) Pub. Date: Jan. 18, 2024

(54) AUTONOMOUS VEHICLE COMPUTE CONTROLLER

(71) Applicant: TUSIMPLE, INC., San Diego, CA (US)

(72) Inventors: Faez YAHYA, San Diego, CA (US); Sridhar KUMAR, Fremont, CA (US); Shimeng WANG, San Diego, CA (US); Changyi ZHAO, San Diego, CA (US); Yuankun ZHU, San Jose, CA (US)

(21) Appl. No.: 18/349,882

(22) Filed: Jul. 10, 2023

Related U.S. Application Data
(60) Provisional application No. 63/368,298, filed on Jul. 13, 2022.

(51) Int. Cl. G06F 13/40

(52) U.S. Cl. CPC G06F 13/4022

(57) ABSTRACT

An autonomous vehicle can include a compute controller that can efficiently perform autonomous driving operations. An apparatus for autonomous vehicle operation comprises an electrical board that includes a plurality of semiconductor devices; a first switch device that is electrically coupled to the plurality of semiconductor devices via a first communication bus of the electrical board; and a second switch device that is electrically coupled to the plurality of semiconductor devices via a second communication bus of the electrical board, where the second switch device is configured to route data between any two or more of the plurality of semiconductor devices using the second communication bus, and where a first data carrying capacity of the first communication bus is independent of a second data carrying capacity of the second communication bus.

### CROSS-REFERENCE TO RELATED APPLICATIONS

This document claims priority to and the benefit of U.S. Provisional Application No. 63/368,298, filed on Jul. 13, 2022. The aforementioned application is incorporated herein by reference in its entirety.

### TECHNICAL FIELD

This document relates to systems, apparatus, and methods for a controller for autonomous vehicles.

### BACKGROUND

Autonomous vehicle navigation is a technology that can allow a vehicle to sense the position and movement of vehicles around an autonomous vehicle and, based on the sensing, control the autonomous vehicle to safely navigate towards a destination. An autonomous vehicle may operate in several modes. In some cases, an autonomous vehicle may allow a driver to operate the autonomous vehicle as a conventional vehicle by controlling the steering, throttle, clutch, gear shifter, and/or other devices. In other cases, a driver may engage the autonomous vehicle navigation technology to allow the vehicle to be driven by itself.

### SUMMARY

An autonomous vehicle includes a compute controller configured to execute calculations and/or operations using resources from a processor (e.g., CPU and/or GPU). The calculations and/or operations performed by a compute controller can enable perception of objects/road in an environment where the autonomous vehicle is operating, planning of trajectory and/or driving related operations (e.g., braking, steering, acceleration/deceleration), and/or control of device(s) for executing the driving related operations (e.g., sending instructions to one or more devices to brake, steer, accelerate/decelerate).

A method of operating an electrical board in a vehicle comprises receiving, by at least one of a plurality of semiconductor devices on the electrical board, images from a camera located on the vehicle; receiving, by a first switch device on the electrical board, sensor data from a plurality of sensors on the vehicle and routing the sensor data to one or more of the plurality of semiconductor devices using a first communication bus of the electrical board; and routing, by a second switch device on the electrical board, data between any two or more of the plurality of semiconductor devices using a second communication bus of the electrical board. In some embodiments, a first data carrying capacity of the first communication bus is independent of a second data carrying capacity of the second communication bus.

A first apparatus for vehicle operation comprises an electrical board that includes: a plurality of semiconductor devices, where at least one of the plurality of semiconductor devices is configured to receive images from a camera located on a vehicle; a first switch device that is electrically coupled to the plurality of semiconductor devices via a first communication bus of the electrical board, where the first switch device is configured to receive sensor data from a plurality of sensors on the vehicle and route the sensor data to one or more of the plurality of semiconductor devices using the first communication bus; and a second switch device that is electrically coupled to the plurality of semiconductor devices via a second communication bus of the electrical board, where the second switch device is configured to route data between any two or more of the plurality of semiconductor devices using the second communication bus. In some embodiments, a first data carrying capacity of the first communication bus is independent of a second data carrying capacity of the second communication bus.

In some embodiments, the first switch device is configured to route the sensor data to the one or more of the plurality of semiconductor devices at a first data rate up to a first maximum data rate, and the second switch device is configured to route the data between the any two or more of the plurality of semiconductor devices at a second data rate up to a second maximum data rate. In some embodiments, the second maximum data rate is higher than the first maximum data rate. In some embodiments, the electrical board further includes:
a plurality of microcontrollers, where each microcontroller is electrically coupled to one semiconductor device and to the second switch device, where each microcontroller includes a memory that stores instructions that upon execution configures a microcontroller to: determine whether a fault condition exists based on information that the microcontroller receives from a semiconductor device to which the microcontroller is electrically coupled; and send a message that includes a fault indication that indicates that the fault condition exists. In some embodiments, the message is sent via the second switch device.

In some embodiments, the electrical board further comprises: a first set of connectors electrically coupled to the first switch device; a second set of connectors electrically coupled to the second switch device; and one or more connectors coupled to a plurality of deserializer devices. In some embodiments, the first set of connectors include at least four connectors, and the second set of connectors include at least two connectors. In some embodiments, the apparatus further comprises a plurality of deserializer devices electrically coupled to two or more of the plurality of semiconductor devices, where at least one of the plurality of deserializer devices is configured to receive the images from the camera and to send the images to the at least one of the plurality of semiconductor devices. In some embodiments, the plurality of semiconductor devices includes a plurality of system-on-chips (SOCs), or a plurality of processors, or a plurality of graphic processing units (GPUs). In some embodiments, the first switch device is different from the second switch device.

In some embodiments, the first switch device includes an ethernet switch device, and where the second switch device includes a peripheral component interconnect express (PCIe) switch device.

A second apparatus for vehicle operation, comprises an electrical board that includes: a plurality of semiconductor devices, where at least one of the plurality of semiconductor devices is configured to receive images from a camera located on a vehicle; a switch device that is electrically coupled to the plurality of semiconductor devices via a first communication bus of the electrical board, where the switch device is configured to receive sensor data from a plurality of sensors on the vehicle and route the sensor data to one or more of the plurality of semiconductor devices using the first communication bus, where the plurality of semiconductor devices are electrically coupled to a second communication bus of the electrical board, where two of the plurality of semiconductor devices are configured to send or receive data between each other via a second communication bus. In some embodiments, a first data carrying capacity of the first communication bus is independent of a second data carrying capacity of the second communication bus.

In some embodiments, the switch device is configured to route the sensor data to the one or more of the plurality of semiconductor devices at a first data rate up to a first maximum data rate, and the two of the plurality of semiconductor devices are configured to send or receive the data at a second data rate up to a second maximum data rate. In some embodiments, the second maximum data rate is higher than the first maximum data rate. In some embodiments, the plurality of semiconductor devices includes a plurality of system-on-chips (SOCs), or a plurality of processors, or a plurality of graphic processing units (GPUs). In some embodiments, the first switch device includes an ethernet switch device, and where the second switch device includes a peripheral component interconnect express (PCIe) switch device.

In yet another exemplary aspect, the above-described method is embodied in a non-transitory computer readable storage medium comprising code that when executed by a processor, causes the processor to perform the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a block diagram of an example vehicle ecosystem for a vehicle that includes a compute controller.

FIG. 2A shows an example design for an electrical board for a compute controller, where the electrical board includes an example quad-semiconductor device design.

FIG. 2B shows an example design for an electrical board for a compute controller, where the electrical board may include an example dual-semiconductor device design.

FIGS. 3A-3B show an example compute controller architecture.

FIG. 4 shows a flow diagram of an exemplary technique to operate a compute controller in an autonomous vehicle.

### DETAILED DESCRIPTION

An autonomous vehicle includes a compute controller that can be designed to enable the autonomous vehicle to perform operations related to perception of objects/road in an environment where the autonomous vehicle is operating, planning of trajectory and/or driving related operations, and/or control of device(s) for executing the driving related operations. A computer controller may include a plurality of electrical boards or a plurality of electrical cards (e.g., a printed circuit board (PCB)), where each electrical board may include a plurality of semiconductor devices (e.g., a system-on-chip (SOC), a processor, and/or a graphic processor unit (GPU)). The semiconductor devices can be interconnected with a high speed switch device (e.g., a peripheral component interconnect express (PCIe) switch device). The design for electrically coupling the plurality of electrical boards will be further described in this patent document. Each electrical board may also include an ethernet switch device that can allow each electrical board to communicate with another electrical board and/or to receive data from some (e.g., LiDARs, Radars, GPS device, etc.) of a plurality of sensors on or in the autonomous vehicle.

As shown below, Section I of this patent document describes an example autonomous vehicle ecosystem for a compute controller. Section II of this patent document describes example designs for an electrical board for a compute controller. Section III of this patent document describes an example compute controller architecture. The example headings for the various sections below are used to facilitate the understanding of the disclosed subject matter and do not limit the scope of the claimed subject matter in any way. Accordingly, one or more features of one example section can be combined with one or more features of another example section.

I. Example Autonomous Vehicle Ecosystem for a Compute Controller

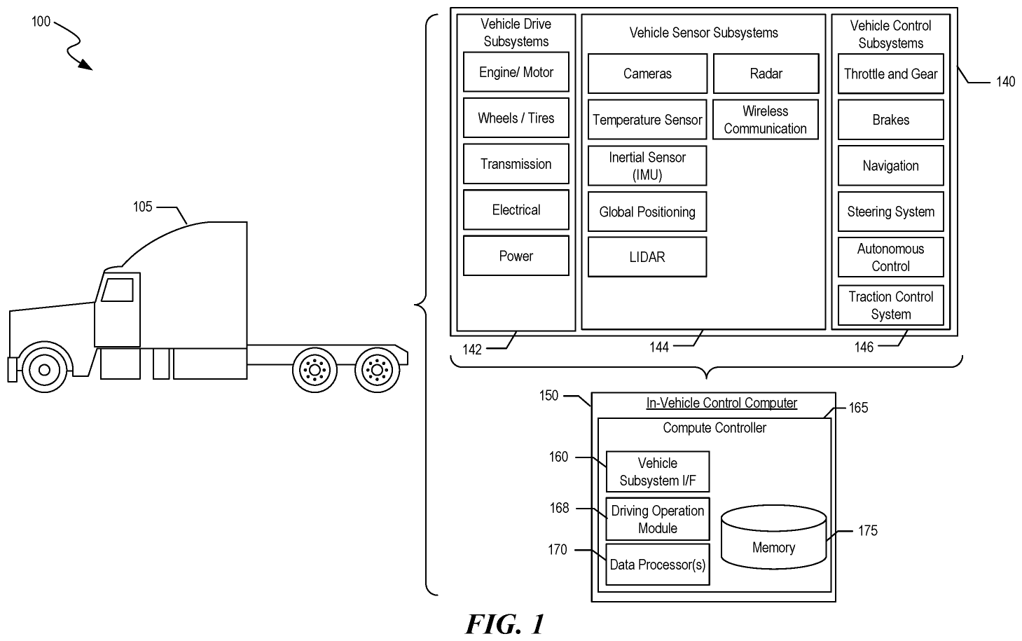

FIG. 1 shows a block diagram of an example vehicle ecosystem 100 for a vehicle 105 that includes a compute controller 165. As shown in FIG. 1, the vehicle 105 may be a semi-trailer truck. The vehicle ecosystem 100 includes several systems and components that can generate and/or deliver one or more sources of information/data and related services to the in-vehicle control computer 150 that may be located in a vehicle 105. The in-vehicle control computer 150 can be in data communication with a plurality of vehicle subsystems 140, all of which can be resident in the vehicle 105. A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140 or the vehicle subsystem interface 160 may include an application programming interface (API).

The vehicle 105 may include various vehicle subsystems that support of the operation of vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiment, additional components or devices can be added to the various subsystems or one or more components or devices (e.g., LiDAR or Radar shown in FIG. 1) can be removed. The vehicle drive subsystem 142 may include components operable to provide powered motion for the vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment or condition of the vehicle 105. As further explained in this patent document, the in-vehicle control computer 150 may include compute controller 165 that can perform operations and/or computations based on sensor data received from the sensor(s) in the vehicle sensor subsystem 144 and can send instructions to one or more devices in the vehicle drive subsystems 142 and/or vehicle control subsystems 146. The vehicle sensor subsystem 144 may include one or more cameras or image capture devices, one or more temperature sensors, an inertial measurement unit (IMU), a Global Positioning System (GPS) transceiver, a laser range finder/LIDAR, a RADAR, and/or a wireless communication unit (e.g., a cellular communication transceiver). The cameras, LIDAR units, and/or RADAR units can be coupled to the vehicle 105. The vehicle sensor subsystem 144 may also include sensors configured to monitor internal systems of the vehicle 105 (e.g., an O₂ monitor, a fuel gauge, an engine oil temperature, etc.,).

The IMU may include any combination of sensors (e.g., accelerometers and gyroscopes) configured to sense position and orientation changes of the vehicle 105 based on inertial acceleration. The GPS transceiver may be any sensor configured to estimate a geographic location of the vehicle 105. For this purpose, the GPS transceiver may include a receiver/transmitter operable to provide information regarding the position of the vehicle 105 with respect to the Earth. The RADAR unit may represent a system that utilizes radio signals to sense objects within the local environment of the vehicle 105. In some embodiments, in addition to sensing the objects, the RADAR unit may additionally be configured to sense the speed and the heading of the objects proximate to the vehicle 105. The laser range finder or LIDAR unit may be any sensor configured to sense objects in the environment in which the vehicle 105 is located using lasers. The cameras may include one or more devices configured to capture a plurality of images of the environment of the vehicle 105. The cameras may be still image cameras or motion video cameras.

The vehicle control subsystem 146 may be configured to control operation of the vehicle 105 and its components. Accordingly, the vehicle control subsystem 146 may include various elements such as a throttle and gear, a brake unit, a navigation unit, a steering system and/or an autonomous control unit. The throttle may be configured to control, for instance, the operating speed of the engine and, in turn, control the speed of the vehicle 105. The gear may be configured to control the gear selection of the transmission. The brake unit can include any combination of mechanisms configured to decelerate the vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the vehicle 105. The navigation unit may additionally be configured to update the driving path dynamically while the vehicle 105 is in operation. In some embodiments, the navigation unit may be configured to incorporate data from the GPS transceiver and one or more predetermined maps so as to determine the driving path for the vehicle 105. The steering system may represent any combination of mechanisms that may be operable to adjust the heading of vehicle 105 in an autonomous mode or in a driver-controlled mode.

The autonomous control unit may represent a control system configured to identify, evaluate, and avoid or otherwise negotiate potential obstacles in the environment of the vehicle 105. In general, the autonomous control unit may be configured to control the vehicle 105 for operation without a driver or to provide driver assistance in controlling the vehicle 105. In some embodiments, the autonomous control unit may be configured to incorporate data from the GPS transceiver, the RADAR, the LIDAR, the cameras, and/or other vehicle subsystems to determine the driving path or trajectory for the vehicle 105.

The traction control system (TCS) may represent a control system configured to prevent the vehicle 105 from swerving or losing control while on the road. For example, TCS may obtain signals from the IMU and the engine torque value to determine whether it should intervene and send instruction to one or more brakes on the vehicle 105 to mitigate the vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

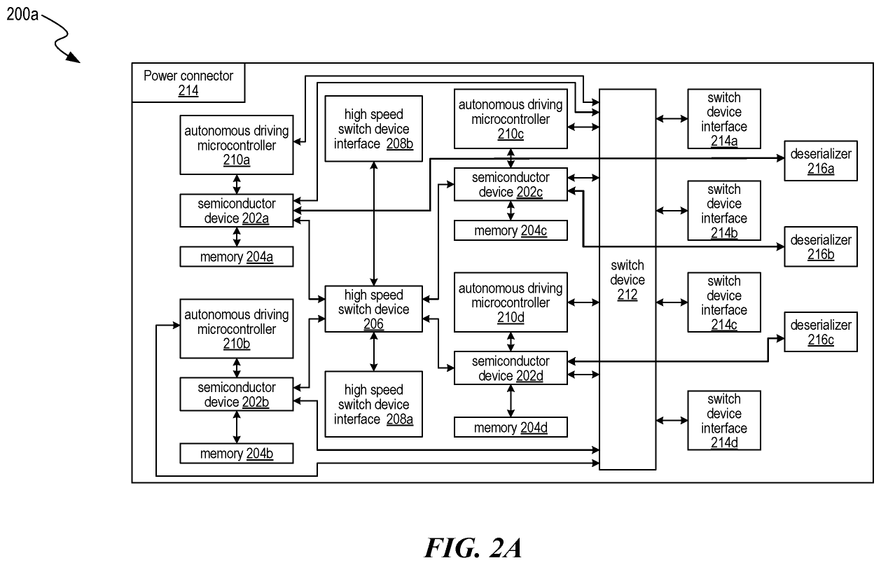

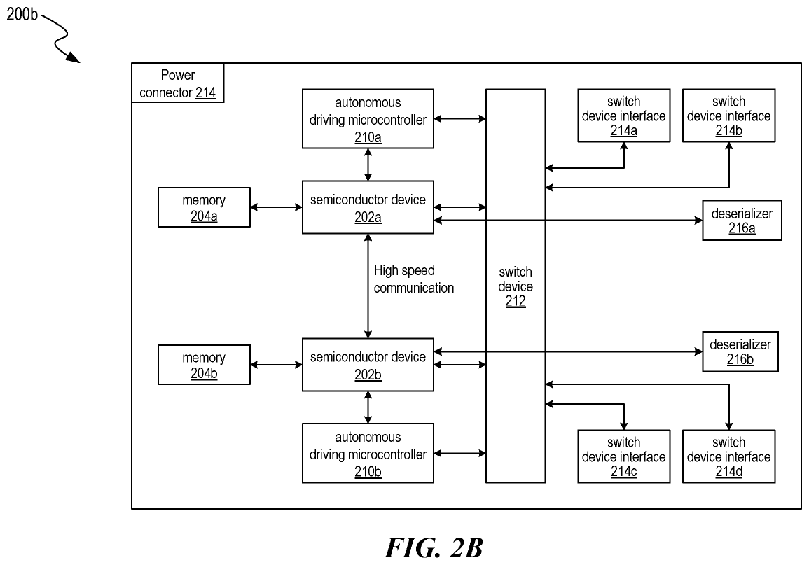

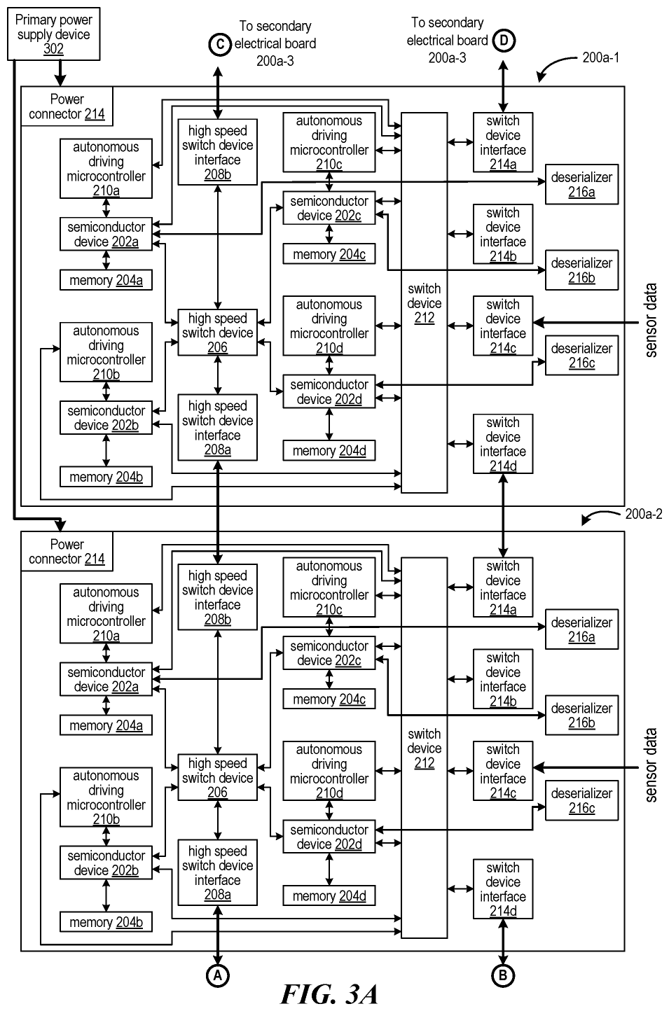

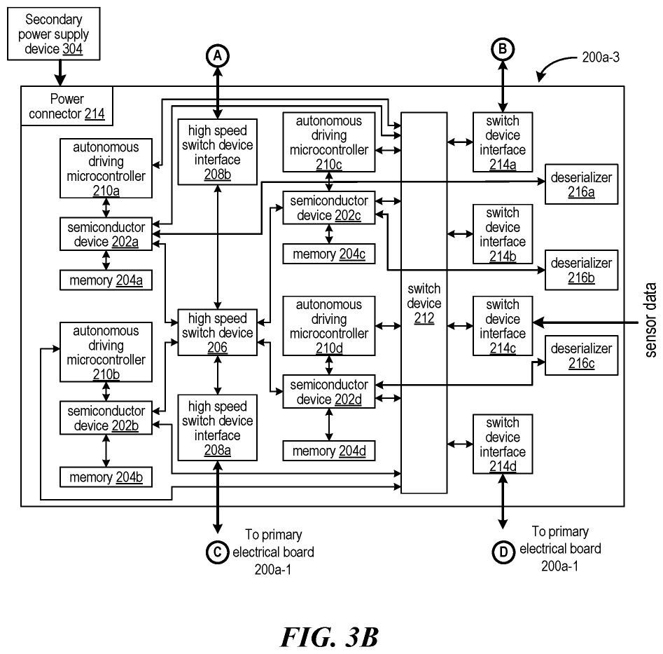

Many or all of the functions of the vehicle 105 can be controlled by the in-vehicle control computer 150. The in-vehicle control computer 150 may include a compute controller 165 as described in this patent document, where the compute controller 165 may include at least one data processor or system-on-chip (SOC) 170 that executes processing instructions stored in a non-transitory computer readable medium, such as memory 175 (or data storage device). The in-vehicle control computer 150 may also represent a plurality of computing devices that may serve to control individual components or subsystems of the vehicle 105 in a distributed fashion. In some embodiments, the memory 175 may contain processing instructions (e.g., program logic) executable by the data processor or SOC 170 to perform various methods and/or functions of the vehicle 105, including those described for the driving operation module 168 as explained in this patent document. The data processor or SOC 170 executes the operations associated with driving operation module 168 for determining various driving related operations of the vehicle 105 based on additional operations or calculations performed by the data processor or SOC 170. In some embodiments, the in-vehicle control computer 150 may include multiple compute controllers 165, where each compute controller may have a design as further described in FIG. 2A or 2B, and where the multiple compute controllers may have an architecture as shown in FIGS. 3A-3B.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 can be configured to include a data processor 170 and a memory 175. The in-vehicle control computer 150 may control the function of the vehicle 105 based on inputs received from various vehicle subsystems (e.g., the vehicle drive subsystem 142, the vehicle sensor subsystem 144, and the vehicle control subsystem 146).

II. Example Designs for an Electrical Board for a Compute Controller

FIG. 2A shows an example design for an electrical board 200a for a compute controller, where the electrical board 200a includes an example quad-semiconductor device design. As shown in FIG. 2A, the electrical board 200a may include four semiconductor devices 202a-202d. A semiconductor device may include a system-on-chip (SOC), a system-on-chip (SOC), a processor, and/or a graphic processor unit (GPU).

Each semiconductor device may be electrically coupled to a memory (e.g., semiconductor device 202a is electrically coupled to memory 204a). The memory can store instructions that can configure the semiconductor device to perform computations or operations for autonomous driving operations. For example, the memory can store information that can allow the semiconductor device to analyze sensor data from sensors (e.g., cameras, LIDARs, etc.,) to determine objects located around the autonomous vehicle when the autonomous vehicle is operating on the road. The memory can also store instructions that can allow the semiconductor devices to determine a trajectory on which the autonomous vehicle should operate or drive, determine driving related operations (e.g., braking, steering, acceleration/deceleration), and/or control of device(s) in the autonomous vehicle for executing the driving related operations. In some embodiments, the memory may be included in each semiconductor device.

The electrical board 200a includes a high-speed switch device 206 (e.g., a PCIe switch device) to which the semiconductor devices (202a to 202d) are electrically coupled. A technical benefit of electrically connecting each semiconductor device to the high-speed switch device is that it can facilitate high speed data sharing or data communication between the semiconductor devices. A technical benefit of data sharing between any two or more of semiconductor devices (202a to 202d) is that computing capabilities of different semiconductor devices can be utilized in a distributed manner so that data can be shared in some embodiments. The high-speed switch device 206 may be a chip that includes an integrated circuit.

The high-speed switch device 208 is electrically coupled to two or more high-speed device interface 208a-208b (e.g., PCIe connectors). A technical benefit of having multiple high-speed device interfaces is that one or more additional electrical boards, which may have the same design as the electrical board 200a, can be electrically connected to the electrical board 200a so that one semiconductor device on the electrical board 200a can send/receive data with one or more semiconductor devices on one or more additional electrical boards via the high-speed switch devices and high-speed device interfaces on the electrical board 200a and on the one or more additional electrical boards.

The electrical board 200a can include autonomous driving microcontrollers 210a-210d, where each autonomous driving microcontroller is electrically coupled to a semiconductor device (e.g., autonomous driving microcontroller 210a is electrically coupled to semiconductor device 202a). The autonomous driving microcontrollers 210a-210d may include memory that can store a program that upon execution configures the autonomous driving microcontrollers 210a-210d to determine whether a fault condition exists based on the information that the autonomous driving microcontrollers receive from the semiconductor devices 202a-202d. The received information may include a flag that indicates that one or more cameras are not operating properly, or a GPS device has not received a GPS signal, etc. If an autonomous driving microcontroller determines that a fault condition exists, the autonomous driving microcontroller can send a message via the switch device 212 to the driving operation module 168 in the in-vehicle control computer 150 (shown in FIG. 1). The message may include a fault indicator that indicates that a fault condition exists and that triggers the driving operation module 168 to perform a safe driving operation response (e.g., send instructions to a steering device and brake device to steer the autonomous vehicle and to apply brakes to stop next to a road). The autonomous driving microcontrollers 210a-210d can be electrically coupled to the switch device 212 so that the autonomous driving microcontrollers 210a-210d can send information to one or more devices in the autonomous vehicle (e.g., the driving operation module 168 of the in-vehicle control computer 150). The switch device 212 may be a chip that includes an integrated circuit.

The electrical board 200a can include a switch device 212 (e.g., Ethernet switch) to which the semiconductor devices 202a-202d can be electrically coupled. The switch device 212 may be electrically coupled to a plurality of switch device interface 214a-214d (e.g., Ethernet connectors) on the electrical board 200 that can allow the switch device 212 to send and receive data from the electrical board 200. For example, a switch device interface can receive data from some of a plurality of sensors (e.g., LIDARs, Radars, etc.,) so that the switch device 202 can route or send sensor data to at least one of the semiconductor devices 202a-202d that may need that information to perform computational tasks. A technical benefit of having at least two switch device interface 214a-214b is that an electrical board 200a can be electrically coupled to a second electrical board and a third electrical board (which may have the same design as electrical board 200a).

As shown in FIG. 2A, the electrical board 200 includes a switch device 212 in addition to the high-speed switch device 206 so that the switch device 212 can receive and send sensor data to the one or more semiconductor devices 202a-202d, and the high-speed switch device 206 can allow data to be sent or received between semiconductor devices. Such a design can be technically advantageous because it can separately send and receive data between the semiconductor devices and other data between a semiconductor device and the sensors without competing for communication resources. The data that is communicated between the semiconductor devices may include data that is analyzed or processed by the semiconductor devices using sensor data received from one or more sensors or cameras on the autonomous vehicle.

The switch device 212 may be coupled to a first communication bus on or in the electrical board 200, and the high-speed switch device 206 may be electrically coupled to a second communication bus on or in the electrical board 200. In some embodiments, the high-speech switch device 206 may allow for data rates that are higher than that allowed by the switch device 212. For example, the switch device 212 may be electrically coupled to a first communication bus so that the switch device 212 can enable communication between a semiconductor device and one or more sensors up to a first data rate. In this example, the high-speed switch device 206 may be electrically coupled to a second communication bus with which the high-speed switch device 206 can enable one semiconductor device to communicate with another semiconductor device on a same electrical board or on another electrical board (as shown in FIGS. 3A-3B) up to a second data rate. In some embodiments, the second data rate may be higher than the first data rate.

In some embodiments, a data carrying capacity of the first communication bus is independent of another data carrying capacity of the second communication bus. For example, the first communication bus can be different than and/or separate from the second communication bus. A technical benefit of having a first communication bus that is separate from or independent of the second communication bus is that it can allow the electrical board 200 to better manage communication resources and/or to minimize contention for communication resources at least because autonomous vehicle operations include sending and receiving a significant amount of data (e.g., data from the sensors, data processed by the semiconductor devices, etc.,).

In FIG. 2A, the electrical board 200a may optionally include a plurality of deserializer devices 216a-216c, where each deserializer device can be electrically coupled to a semiconductor device, and where each deserializer device can be electrically coupled to one or more camera (e.g., via one or more connectors on the electrical board 200a). On the electrical board 200a, at least one semiconductor device may receive images from one or more cameras via at least one deserializer device so that the at least one semiconductor device may perform image processing on the images from the one or more cameras. The electrical board 200a can include a power connector 214 that allows the electrical board 200a to receive power from a power supply device in autonomous vehicle.

FIG. 2B shows an example design for an electrical board 200b for a compute controller, where the electrical board 200b may include an example dual-semiconductor device design. As shown in FIG. 2B, the electrical board 200b may include two semiconductor devices 202a-202b. In FIG. 2B, the two semiconductor devices 202a-202b may be electrically coupled to each other via a high-speed communication bus (e.g., PCIe bus). FIG. 2B shows devices with same reference numerals as in FIG. 2A to indicate that the devices and/or operations performed by the devices in FIG. 2B can be the same as the devices and/or operations performed by the devices as described in FIG. 2A.

III. Example Compute Controller Architecture

FIGS. 3A-3B show an example compute controller architecture. The compute controller architecture includes a plurality of electrical boards 200a-1 to 200a-3, where FIG. 3A shows electrical boards 200a-1 to 200a-2, and where FIG. 3B shows electrical board 200a-3. In FIGS. 3A-3B, each of the electrical boards (200a-1, 200a-2, or 200a-3) can have a same design as shown for electrical board 200a in FIG. 2A. In some embodiments, the third electrical board 200a-3 may perform redundant computations with the first electrical board 200a-1 so that the third electrical board 200a-3 can perform basic autonomous driving related operations in case the first electrical board 200a-1 fails. The semiconductor device(s) of the third electrical board 200a-3 may perform operations using sensor data that can be received from a minimum number of sensors via a switch device interface 214c and/or via one or more deserializer devices 216a-216c on the third electrical board 200a-3. The minimum number of sensors may be a predefined number of sensors and/or may include sensors that are previously identified as being necessary for performing basic autonomous driving related operations.

In some embodiments, the plurality of sensors (e.g., a first set of cameras, LIDARs, and/or or RADARS) that send data to the second electrical board 200a-2 may be different than and less than the plurality of sensors (e.g., a second set of cameras, LIDARs, and/or RADARS) that send data to the first electrical board 200a-1. In some embodiments, a number of the minimum number of sensors (e.g., a third set of cameras, LIDARs, and/or or RADARS) that send data to the third electrical board 200a-3 may be the same as the number of the plurality of sensors (e.g., a second set of cameras, LIDARs, and/or RADARS) that send data to the second electrical board 200a-2.

In FIG. 3A, the first two electrical boards 200a-1, 200a-2 are connected to a primary power supply device 302 located in the autonomous vehicle, and in FIG. 3B, the third electrical board 200a-3 is connected to a third power supply device 304. A technical benefit of having electrical boards receive power from separate power supply devices is to facilitate a redundant or backup architecture so that if the primary power supply device 302 fails, the third power supply device 304 can continue to power electrical board 200a-3 so that the devices in the electrical board 200a-3 can continue to perform operations and/or computations.

The first electrical board 200a-1 can be electrically coupled to the third electrical board 200a-3 via the high-speed device interface 208b on electrical board 200a-1 and high-speed device interface 208a on electrical board 200a-3. The first electrical board 200a-1 can also be electrically coupled to the second electrical board 200a-2 via the high-speed device interface 208a on electrical board 200a-1 and high-speed device interface 208b on the second electrical board 200a-2. The second electrical board 200a-2 can be electrically coupled to the third electrical board 200a-3 via the high-speed device interface 208a on the second electrical board 200a-2 and high-speed device interface 208b on electrical board 200a-3. In some embodiments, the connection of each electrical board to at least two electrical boards can enable communication or data sharing between a semiconductor device one electrical board and semiconductor devices on at least two electrical boards.

The first electrical board 200a-1 can also be electrically coupled to the third electrical board 200a-3 via the switch device interface 214a on electrical board 200a-1 and switch device interface 214d on electrical board 200a-3. The first electrical board 200a-1 can also be electrically coupled to the second electrical board 200a-2 via the switch device interface 214d on electrical board 200a-1 and switch device interface 214a on the second electrical board 200a-2. The second electrical board 200a-2 can be electrically coupled to the third electrical board 200a-3 via the switch device interface 214d on the second electrical board 200a-2 and switch device interface 214a on electrical board 200a-3. In some embodiments, the connection of each electrical board to at least two electrical boards can enable communication or data sharing between devices on the electrical boards. In some embodiments, the switch device 212 on one electrical board may be operatable to send data to or receive data from another electrical board up to a data rate that is higher than another data rate used by the switch device 212 on the one electrical board to send sensor data received from a sensor on an autonomous vehicle to a semiconductor device on the one electrical board.

In some embodiments where the electrical board use a dual-semiconductor device design as shown in FIG. 2B, a compute controller may include up to six electrical boards. In such a configuration, each electrical board may be connected to at least two electrical boards via the switch device interfaces on the electrical boards.

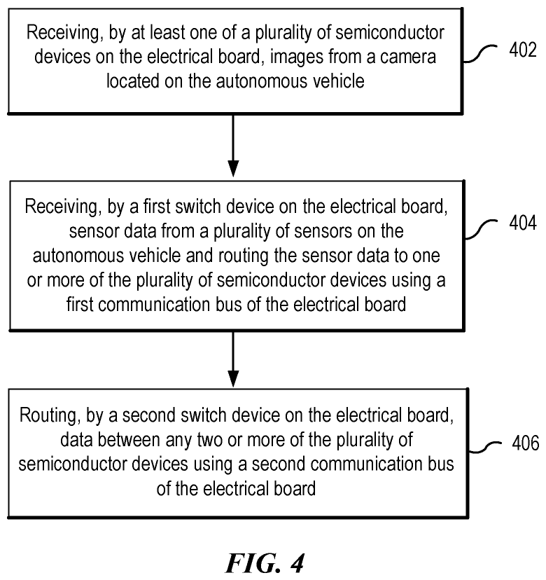

FIG. 4 shows a flow diagram of an exemplary technique to operate a compute controller in an autonomous vehicle. Operation 402 includes receiving, by at least one of a plurality of semiconductor devices on an electrical board, images from a camera located on the autonomous vehicle. The electrical board is located in an autonomous vehicle. Operation 404 includes receiving, by a first switch device on the electrical board, sensor data from a plurality of sensors on the autonomous vehicle and routing the sensor data to one or more of the plurality of semiconductor devices using a first communication bus of the electrical board. Operation 406 includes routing, by a second switch device on the electrical board, data between any two or more of the plurality of semiconductor devices using a second communication bus of the electrical board. In some embodiments, a first data carrying capacity of the first communication bus is independent of a second data carrying capacity of the second communication bus.

In some embodiments, the sensor data is routed to the one or more of the plurality of semiconductor devices at a first data rate up to a first maximum data rate, and the data is routed between the any two or more of the plurality of semiconductor devices at a second data rate up to a second maximum data rate. In some embodiments, the second maximum data rate is higher than the first maximum data rate. In some embodiments, the method further comprises determining, by a microcontroller on the electrical board, whether a fault condition exists based on information that the microcontroller receives from a semiconductor device from the plurality of semiconductor devices; and sending, by the microcontroller, a message that includes a fault indication that indicates that the fault condition exists. In some embodiments, the message is sent via the second switch device. In some embodiments, the plurality of sensors include light detection and ranging (LIDAR) devices or RADAR devices.

In some embodiments, an apparatus for autonomous vehicle operation comprises an electrical board that includes: a plurality of semiconductor devices, where at least one of the plurality of semiconductor devices is configured to receive images from a camera located on an autonomous vehicle; a first switch device that is electrically coupled to the plurality of semiconductor devices via a first communication bus of the electrical board, where the first switch device is configured to receive sensor data from a plurality of sensors on the autonomous vehicle and route the sensor data to one or more of the plurality of semiconductor devices using the first communication bus; and a second switch device that is electrically coupled to the plurality of semiconductor devices via a second communication bus of the electrical board, where the second switch device is configured to route data between any two or more of the plurality of semiconductor devices using the second communication bus. In some embodiments, a first data carrying capacity of the first communication bus is independent of a second data carrying capacity of the second communication bus.

In some embodiments, the first switch device is configured to route the sensor data to the one or more of the plurality of semiconductor devices at a first data rate up to a first maximum data rate, and the second switch device is configured to route the data between the any two or more of the plurality of semiconductor devices at a second data rate up to a second maximum data rate. In some embodiments, the second maximum data rate is higher than the first maximum data rate. In some embodiments, the electrical board further includes:
a plurality of microcontrollers, where each microcontroller is electrically coupled to one semiconductor device and to the second switch device, where each microcontroller includes a memory that stores instructions that upon execution configures a microcontroller to: determine whether a fault condition exists based on information that the microcontroller receives from a semiconductor device to which the microcontroller is electrically coupled; and send a message that includes a fault indication that indicates that the fault condition exists. In some embodiments, the message is sent via the second switch device.

In some embodiments, the electrical board further comprises: a first set of connectors electrically coupled to the first switch device; a second set of connectors electrically coupled to the second switch device; and one or more connectors coupled to a plurality of deserializer devices. In some embodiments, the first set of connectors include at least four connectors, and the second set of connectors include at least two connectors. In some embodiments, the apparatus further comprises a plurality of deserializer devices electrically coupled to two or more of the plurality of semiconductor devices, where at least one of the plurality of deserializer devices is configured to receive the images from the camera and to send the images to the at least one of the plurality of semiconductor devices. In some embodiments, the plurality of semiconductor devices includes a plurality of system-on-chips (SOCs), or a plurality of processors, or a plurality of graphic processing units (GPUs). In some embodiments, the first switch device is different from the second switch device.

In some embodiments, the first switch device includes an ethernet switch device, and where the second switch device includes a peripheral component interconnect express (PCIe) switch device.

A second apparatus for autonomous vehicle operation, comprises an electrical board that includes: a plurality of semiconductor devices, where at least one of the plurality of semiconductor devices is configured to receive images from a camera located on an autonomous vehicle; a switch device that is electrically coupled to the plurality of semiconductor devices via a first communication bus of the electrical board, where the switch device is configured to receive sensor data from a plurality of sensors on the autonomous vehicle and route the sensor data to one or more of the plurality of semiconductor devices using the first communication bus, where the plurality of semiconductor devices are electrically coupled to a second communication bus of the electrical board, where two of the plurality of semiconductor devices are configured to send or receive data between each other via a second communication bus. In some embodiments, a first data carrying capacity of the first communication bus is independent of a second data carrying capacity of the second communication bus.

In some embodiments, the switch device is configured to route the sensor data to the one or more of the plurality of semiconductor devices at a first data rate up to a first maximum data rate, and the two of the plurality of semiconductor devices are configured to send or receive the data at a second data rate up to a second maximum data rate. In some embodiments, the second maximum data rate is higher than the first maximum data rate. In some embodiments, the plurality of semiconductor devices includes a plurality of system-on-chips (SOCs), or a plurality of processors, or a plurality of graphic processing units (GPUs). In some embodiments, the first switch device includes an ethernet switch device, and where the second switch device includes a peripheral component interconnect express (PCIe) switch device.

In this document the term “exemplary” is used to mean “an example of” and, unless otherwise stated, does not imply an ideal or a preferred embodiment. In the patent document the compute controllers are employed in autonomous vehicle that include “semi-trailer truck. However, the compute controllers may also be used in other kinds of vehicles.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. An apparatus for vehicle operation, comprising:
an electrical board that includes:
a plurality of semiconductor devices, wherein at least one of the plurality of semiconductor devices is configured to receive images from a camera located on a vehicle;
a first switch device that is electrically coupled to the plurality of semiconductor devices via a first communication bus of the electrical board,
wherein the first switch device is configured to receive sensor data from a plurality of sensors on the vehicle and route the sensor data to one or more of the plurality of semiconductor devices using the first communication bus; and
a second switch device that is electrically coupled to the plurality of semiconductor devices via a second communication bus of the electrical board,
wherein the second switch device is configured to route data between any two or more of the plurality of semiconductor devices using the second communication bus.

2. The apparatus of claim 1,
wherein the first switch device is configured to route the sensor data to the one or more of the plurality of semiconductor devices at a first data rate up to a first maximum data rate, and
wherein the second switch device is configured to route the data between the any two or more of the plurality of semiconductor devices at a second data rate up to a second maximum data rate.

3. The apparatus of claim 2, wherein the second maximum data rate is higher than the first maximum data rate.

4. The apparatus of claim 1, wherein the electrical board further includes:
a plurality of microcontrollers,
wherein each microcontroller is electrically coupled to one semiconductor device and to the second switch device,
wherein each microcontroller includes a memory that stores instructions that upon execution configures a microcontroller to:
determine whether a fault condition exists based on information that the microcontroller receives from a semiconductor device to which the microcontroller is electrically coupled; and
send a message that includes a fault indication that indicates that the fault condition exists.

5. The apparatus of claim 4, wherein the message is sent via the second switch device.

6. The apparatus of claim 1, wherein the electrical board further comprises:
a first set of connectors electrically coupled to the first switch device;
a second set of connectors electrically coupled to the second switch device; and
one or more connectors coupled to a plurality of deserializer devices.

7. The apparatus of claim 6, wherein the first set of connectors include at least four connectors, and the second set of connectors include at least two connectors.

8. The apparatus of claim 1, further comprising:
a plurality of deserializer devices electrically coupled to two or more of the plurality of semiconductor devices,
wherein at least one of the plurality of deserializer devices is configured to receive the images from the camera and to send the images to the at least one of the plurality of semiconductor devices.

9. The apparatus of claim 1, wherein the plurality of semiconductor devices includes a plurality of system-on-chips (SOCs), or a plurality of processors, or a plurality of graphic processing units (GPUs).

10. The apparatus of claim 1, wherein the first switch device is different from the second switch device.

11. The apparatus of claim 1, wherein a first data carrying capacity of the first communication bus is independent of a second data carrying capacity of the second communication bus.

12. A method of operating an electrical board in a vehicle, comprising:
receiving, by at least one of a plurality of semiconductor devices on the electrical board, images from a camera located on the vehicle;
receiving, by a first switch device on the electrical board, sensor data from a plurality of sensors on the vehicle and routing the sensor data to one or more of the plurality of semiconductor devices using a first communication bus of the electrical board; and
routing, by a second switch device on the electrical board, data between any two or more of the plurality of semiconductor devices using a second communication bus of the electrical board.

13. The method of claim 12,
wherein the sensor data is routed to the one or more of the plurality of semiconductor devices at a first data rate up to a first maximum data rate, and
wherein the data is routed between the any two or more of the plurality of semiconductor devices at a second data rate up to a second maximum data rate.

14. The method of claim 13, wherein the second maximum data rate is higher than the first maximum data rate.

15. The method of claim 12, further comprising:
determining, by a microcontroller on the electrical board, whether a fault condition exists based on information that the microcontroller receives from a semiconductor device from the plurality of semiconductor devices; and
sending, by the microcontroller, a message that includes a fault indication that indicates that the fault condition exists.

16. The method of claim 15, wherein the message is sent via the second switch device.

17. The method of claim 12, wherein the plurality of sensors include light detection and ranging (LIDAR) devices or RADAR devices.

18. The method of claim 12, wherein a first data carrying capacity of the first communication bus is independent of a second data carrying capacity of the second communication bus.
